(19) United States
(12) Patent Application Publication
(10) Pub. No.: US 2015/0291458 A1
(43) Pub. Date: Oct. 15, 2015

(54) Ground Water Treatment System and Methods of Use

(71) Applicant: SANECOTEC LTD., Ottawa (CA)

(72) Inventors: Jim SHUBAT, Ottawa (CA); Jeff BYRON, Elginburg (CA); Ludo FEYEN, Heusden-Zolder (BE)

(21) Appl. No.: 14/686,756

(22) Filed: Apr. 14, 2015

Related U.S. Application Data
(60) Provisional application No. 61/979,507, filed on Apr. 14, 2014.

(51) Int. Cl. C02F 1/72

(52) U.S. Cl. CPC C02F 1/722; C02F 2103/06

(57) ABSTRACT

A system and methods of treating groundwater to provide potable water for non-municipal or residential networks using stabilized hydrogen peroxide as a primary oxidant. Residual stabilized hydrogen peroxide is maintained as a secondary disinfectant and integrity indicator in the post-treatment water flow.

### CROSS REFERENCE TO RELATED APPLICATION

The present application claims the benefit of U.S. Patent Application No. 61/979,507 which is hereby expressly incorporated by reference in its entirety.

### FIELD OF INVENTION

The present invention relates to a system and method to treat source groundwater. More particularly, the invention relates to the use of stabilized hydrogen peroxide as a primary and secondary water treatment and as an indicator of water integrity in a water distribution system.

### BACKGROUND

Many people, organizations and businesses rely on water from a groundwater or surface water source that has not been treated by a municipal treatment and distribution system. Groundwater and surface water may contain a variety of particles, organic compounds, sediment, dissolved minerals or compounds and organisms that affect characteristics such as taste, smell or health safety of the water. In the absence of a municipal system, water treatment requires the use of a variety of physical and chemical methods to mitigate risks and improve quality associated with a groundwater source. Such treatments can vary depending on the source water composition, particularly with respect to pH, water hardness, sulphur, nitrogen, iron, manganese, other mineral content or dissolved solids. Additionally, source groundwater may contain constituents such as microbes (i.e. viruses, moulds, fungi and bacteria); minerals, including salts, nitrates and metals, that can be naturally-occurring or be the result of human activity; pesticides and herbicides from agricultural or horticultural practices; organic chemicals from industry, gasoline stations, agriculture, storm-water runoff, or a septic system.

Water treatment systems are designed to receive groundwater and, by a series of one or more treatments, improve the water quality and health safety for human, animal or plant use. The treatments used are dependent upon the specific water chemistry of a groundwater source with respect to such components as organic content, mineral and biological components of a particular groundwater source.

Typical treatments include the use of sediment filters, reverse osmosis, UV irradiation, multimedia filters, carbon filters, softeners, mixed bed and split bed demineralization, specialty ion exchangers. Strong oxidizers such as chlorine may be used to oxidize the unwanted dissolved iron, manganese, sulphur compounds.

Current water treatment systems use a variety of physical and chemical methods to improve smell and taste, and treatment to provide protection against biological organisms. These may include methods such as, reverse osmosis, anion exchange, ultraviolet light (UV) irradiation, charcoal or activated alumina filters, sediment filters, chlorine, potassium permanganate, ozone treatment, ozone plus hydrogen peroxide treatment and hydrogen peroxide treatment. Current systems using hydrogen peroxide include a filter or other method to remove residual hydrogen peroxide before the water enters a distribution system. A treatment system may use a combination of methods as dictated by the water characteristics of the source water being treated.

Removal of iron, manganese, sulphur or other organic compounds by filtration requires oxidation to a state in which they can form insoluble complexes. Common oxidants used in water treatment include chemicals such as chlorine, chlorine dioxide, potassium permanganate, or gases such as oxygen or ozone introduced into the water flow by an air pump or venture apparatus. Oxidation using oxygen, chlorine or potassium permanganate is frequently applied in small groundwater systems.

Primary disinfection in water treatment systems has the objective of applying at or shortly after the source a disinfectant to destroy or inactivate pathogenic organisms in untreated water. Secondary disinfectant has the objective of applying to treated water, that is water which is already treated by a primary disinfectant, another disinfectant to preserve the integrity of the water in the distribution system.

Disinfectants such as chlorine are often used in a water treatment system against waterborne disease-causing organisms. Chlorine, at appropriate concentrations, can remain as a residual in distributed water and has traditionally been acceptable for human and animal consumption. In this way, the common understanding has been that the integrity of the water in the distribution network is protected by a residual chlorine level. However, a drawback of halogenated oxidation and disinfection, whether in the role of primary oxidant or as a primary disinfectant or as a secondary disinfectant, is the formation of disinfection byproducts (DBPs), which form when halogenated compounds react with naturally occurring organic material in the water. DBPs formed through the use of chlorine and chloramine can include trihalomethanes (THMs), such as chloroform, bromoform, bromodichloromethane, and dibromochloromethane and haloacetic acids (HAAs) such as monochloro-, dichloro-, trichloro-, monobromo-, dibromo-haloacetic acids. Additionally, chlorine use has a deleterious effect on plumbing components, speeding degradation or corrosion. It is also known that the effectiveness of chlorine as a disinfectant diminishes with an increase in the water's pH and an increase in temperature.

Some water treatment technologies use ozone, alone or in combination with hydrogen peroxide, but the cost and complexity of these systems preclude widespread adoption, particularly on a small scale such as that found for a residence, farm or business or other non-municipal system.

Current use of hydrogen peroxide in a groundwater treatment system is primarily as a down-well process. In this process, hydrogen peroxide is used as a pre-oxidant for applications such as, taste and odor control, hydrogen sulfide removal, iron removal, and may optionally be used in combination with ozone. In this process hydrogen peroxide is mixed into the groundwater source, typically directly into a well. Typically as a high concentration pulse treatment. Organic contaminants such as hydrogen sulphide are oxidized and the hydrogen peroxide is either consumed through the oxidative reactions or removed from the water flow by catalytic carbon-based filters prior to entry into the distribution of the final treated water.

Stabilized hydrogen peroxide (SHP) solutions used for water disinfection, such as HUWA-SAN™ owned by Roam Chemie NV of Houthalen, Belgium, and SANOSIL™ owned by Sanosil Ltd, of Hombrechtikon, of Switzerland are known in the art. Such hydrogen peroxide solutions are proprietary and are stabilized by minute concentrations of silver ions or silver colloid. The silver prevents the hydrogen peroxide from oxidizing too quickly when it contacts water, thereby allowing the solution to mix with the water before interacting with and disinfecting undesirable organisms and chemicals.

Hydrogen peroxide is also available as a food grade and a chemical grade product. These peroxides have been used in water treatments such as, alone or in combination with ozone treatment or as a down-well injection of hydrogen peroxide treatment. These treatments using hydrogen peroxide include a subsequent treatment step that results in removal of residual hydrogen peroxide such that HP is not present in the distributed water stream.

Biofilm is a problem and concern within a treatment and distribution system. A biofilm is comprised of microbial growth on the surfaces of the treatment and distribution system, for example a pipe inner surface, a pump or valve surface, or within a filter. The microbial organism may be a bacteria, a mould, a fungi, or a virus. Removal of biofilm can be achieved by purging a system with periodic high doses of chlorine, followed by thorough flushing of the system. A residual chlorine level in a distribution system is, generally, not an effective method to maintain biofilm control in the system or an effective method of inhibiting biofilm accumulation. While single point reduction of organisms is possible with treatments such as UV irradiation, no ongoing protection is provided throughout the remainder of the treatment or distribution system.

Initial water quality, i.e. the chemical, organic and biological composition are factors which alter the design of a water treatment system. The four major parameters under consideration are, iron, sulphur and total dissolved solid levels and dissolved organic carbon. Higher levels of these water components could require higher dose rates of SHP and will be a consideration as to the choice of filters and treatments.

In agricultural applications groundwater is often sourced from open surface ponds. The groundwater in this case may have considerable microbial and algal populations, particularly during the warm summer months. The biological load in irrigation or fertilization water can lead to reduced plant growth and productivity.

A water treatment system is required which includes treatment with SHP and filtration of undesirable particles, and further requires the maintenance of a residual amount of SHP in distributed potable water.

### SUMMARY

The present invention discloses a water treatment system for use in treating groundwater using stabilized hydrogen peroxide (SHP). SHP is introduced into a water flow by a dosing apparatus and subsequently filtered to remove particles. A distribution system transports treated water to at least one outlet. A network of pipes connects the water source to the treatment system and from the treatment system to the distribution system. The introduction of SHP is sufficient to provide a residual SHP level in water within the distribution system.

In one embodiment, one or more monitoring apparatus are provided to measure the residual level if SHP in the water.

In a further embodiment, a control unit receives a signal indicating the level of SHP and is configured to provide a signal to one or more dosing apparatus to control the effective rate of SHP introduction.

In one embodiment the effective residual level is maintained between 1 mg/L and 8 mg/L.

In another embodiment, the effective residual level is maintained between 2 mg/L and 8 mg/L.

In another embodiment, the effective residual level is maintained between 4 mg/L and 8 mg/L.

In a further aspect of the invention, a method of treatment for ground water is provided comprising introducing SHP into the water system at an effective rate. Sampling and measuring the residual SHP level in the water in the distribution system and determining if the SHP level is within a predetermined standard. If required, altering the effective rate of SHP introduction to obtain residual SHP levels in the distribution system that are within the predetermined standards.

### BRIEF DESCRIPTION OF THE DRAWINGS

Embodiments are illustrated by way of example and not limitation in the following FIGURE.

FIG. 1 is a schematic of one embodiment of the water treatment system of the present invention that uses SHP as a primary disinfectant.

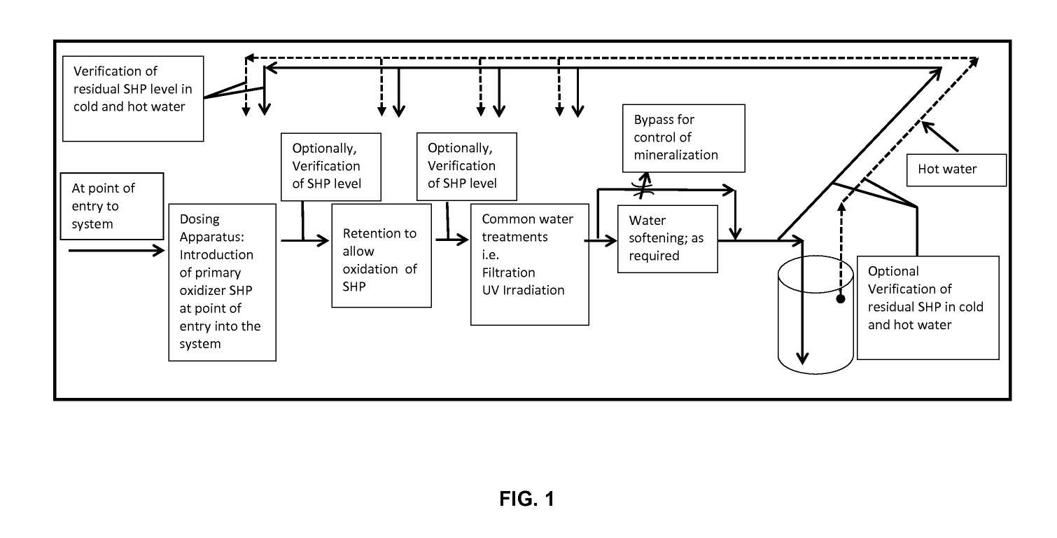

### DETAILED DESCRIPTION

Example embodiments, as described below, may be used to provide a water treatment and distribution systems using SHP.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In the case of conflict, the present specification, including definitions, will control. In addition, the materials, methods, and examples are illustrative only and not intended to be limiting.

The term groundwater, as used herein, is understood to include water that is present below the earth's surface, such as in aquifers or underground streams, and to further include water present on the surface of the ground such as lakes, ponds or rivers.

A distribution system means a network of pipes, for transporting potable water, connecting the treatment system to one or more water outlets, such as a tap. A distribution system may include a holding tank for potable water. A distribution system may transport potable water to outlets present in nearby buildings or at outdoor locations.

A residual level of SHP refers to a level of SHP remaining in the water after treatment, for example, water in a distribution system. An effective residual level of SHP refers to a range of concentration within a determined range wherein antimicrobial effects are achieved and are within a range suitable and approved for human consumption (i.e. 1-8 ppm).

An acceptable SHP is a stabilized hydrogen peroxide that has the capacity to demonstrate the following; a level of antimicrobial activity, equivalent to or better than conventional disinfectants such as chlorine; have antimicrobial and oxidative activity at a wide pH range (i.e. pH 2-pH 9); is stable and maintains a residual level in hot or cold water (as commonly found in a residential water system) for a prolonged period of time (i.e. 5-10 days); meets governmental requirements for use in drinking water (i.e. food grade or NSF 60 approval); has no harmful degradation products; and shows inhibition properties against biofilm formation.

In one embodiment a treatment system is modified with a first dosing apparatus to introduce an effective amount of SHP solution. A SHP may be supplied as HUWA-SAN™ or other stabilized hydrogen peroxide at a dosing rate to provide an effective amount in the water flow. A SHP may be supplied at a concentration that could range from 1% to 25% and introduced at a dosing rate such that the diluted SHP provides an effective amount in the water flow.

In one embodiment sediment free groundwater is supplied to a treatment system, a dosing apparatus introduces SHP into the water flow at the point of entry into the treatment system and acts as a primary oxidant. For primary oxidation or disinfection of organic components in the water to occur, exposure to SHP for a suitable time is required. Depending on the organic components present in the source groundwater a suitable time may be achieved either with or without use of a holding tank. Optionally, dosed water may be held in a holding tank for a suitable period of time to allow primary oxidation or disinfection of organic components of the water. A suitable period of time may be up to 30 minutes in duration or as determined based on the quality of the groundwater source. The SHP oxidizes organic compounds which can be removed by a filtration method of choice, such as but not limited to anthracite greensand filters or Next-Sand™ or other mixed filter media. The filters used must not remove SHP, leaving an effective residual SHP level in the water flow to act as a secondary disinfectant. In some embodiments, water conditioning treatments are included in the system such as a water softener to reduce the calcium (hardness) to appropriate levels. Potable water may be stored in a reservoir or hot water tank before entering a distribution system.

In an alternative embodiment, a treatment system has a filter that does remove SHP from the water flow upstream of the distribution system. In this case, a second dosing unit is provided downstream of the filter to introduce an effective amount of SHP solution prior to treated water entering the distribution system. As such, there is a residual, measurable amount of SHP downstream of the filter.

Detection of hydrogen peroxide levels can be accomplished by a variety of means. For example, test strips such as Precision Laboratories™ 0-100 ppm H2O2 test strips, or a monitoring apparatus such as a D141 Handheld™ digital meter (0-180 ppm) from SanEcoTec™ are used to test samples taken from the distribution system (grab samples). Alternatively a monitoring apparatus may comprise an automated monitoring apparatus that is integrated into the system to provide continuous sampling and monitoring of residual SHP levels. The monitoring apparatus may be configured to interact with a control unit. The control unit may further be configured to interact with one or more dosing apparatus thereby forming a looped system for control of SHP levels in the system. The control unit may also include a control system functionality having a H₂O₂ dosing and control algorithm that compares the measured H₂O₂ concentration to a set point that defines the desired concentration of H₂O₂ in the water treatment and distribution system. The set point may be defined as a discrete value such as 8 ppm or as a range such as between 2-10 ppm. A set point can be used to define the established standard or the established threshold. The control system is further configured to control a H₂O₂ dosing apparatus of the water treatment and distribution system in response to the measured H₂O₂ concentration and the set point. The dosing apparatus is located upstream of the monitoring apparatus such that additions of H₂O₂ made by the dosing apparatus are monitored by the monitoring apparatus and subsequent measurements are re-evaluated by the dosing algorithm relative to the set point. A water treatment and distribution system may have multiple monitoring apparatus for measurement and multiple control units distributed throughout the treatment and distribution system. Alternatively, one control system may obtain input from multiple monitoring apparatus and control multiple dosing apparatus.

An exemplary dosing and control algorithm is a Proportional-Integral-Derivative (PID) control algorithm. A PID control is a common control algorithm used in industry and has been universally accepted in industrial control. PID controllers have robust performance in a wide range of operating conditions and their functional simplicity allows for ease of operation.

Under a PID control, or other such control algorithm, the control unit can be configured to direct the actions of the dosing apparatus to provide an effective amount of SHP and thereby maintain a desired residual SHP level in the distribution system.

An effective amount of SHP to act as a primary oxidant may be determined empirically by setting an initial dosing rate of SHP based on flow metering. An initial rate may be guided by water quality analysis that indicates the level of organic components in the water flow. For example, an initial rate may be set between 2 mg/L and 20 mg/L (2 ppm to 20 ppm). The system is run and allowed to equilibrate, a sample of water is obtained from the distribution system and the SHP level determined. In one embodiment, the sample is obtained from a distant point of the distribution system. In another embodiment, the residual SHP level in the distribution system is greater than 1 mg/L and no more than 8 mg/L (1 ppm to 8 ppm). In another embodiment, the residual SHP is between 2 mg/L and 8 mg/L. In a further embodiment, the residual SHP is between 4 mg/L and 8 mg/L. If the measured levels of residual SHP are not in a preferred range the first dosing apparatus is adjusted to introduce more or less SHP as required. After a period of time for the system to re-equilibrate, the residual SHP level in the distribution system is re-tested. The above process is repeated until the desired level of residual SHP remains in the distribution system.

Alternatively, the system may include more than one dosing apparatus and more than one monitoring apparatus. If the measured level of residual SHP remains within established guidelines for a given application, for example for potable water between 2-8 ppm (Ontario, Canada), no further treatment is required. If the measured level falls below an acceptable range, additional SHP is injected in the system by a dosing apparatus. If measured levels are above the acceptable range, adjustment is made to reduce the dosing rate.

In a further embodiment, a method of using residual SHP levels and changes therein as an indicator of water integrity is provided. A residual SHP level present in the distribution system, such as at a location distant from the treatment system, is within established guidelines, an indication that water integrity is maintained. If the residual SHP level is below established guidelines, an indication that SHP is being used to oxidize organic material or microorganisms, thereby being depleted, and that the water integrity is at risk. Alternatively, if residual SHP levels are obtained from more than one monitoring location, each progressively more downstream than the previous, the difference, if any, of residual SHP levels indicates oxidation of hydrogen peroxide and therefore an indication of water integrity risk.

Alternative means of measuring water integrity are available and can be used alone or in combination. These methods may compliment measurement of residual SHP levels. Assessment of water integrity can be monitored by alternative means, such as detection and quantification of adenosine triphosphate (ATP) levels in a water sample. ATP is a component of living cells and can be used as an indicator of a biological population in a water sample. Within a water sample there will be ATP present from two sources, intra-cellular ATP is that present within living cells and extra-cellular ATP located outside of living cells. Extra-cellular ATP is released from dead or stressed cells and may be free in solution or bound to organics in the water. The total amount of ATP in a sample is the combination of extra-cellular and intra-cellular ATP. By determination of the total ATP content and subtracting the extra-cellular ATP content a measure of ATP from living cells can be derived. Therefore an indication of the live biological population can be determined.

Residual SHP and ATP data is collected to provide an assessment of water integrity and is correlated for use in determining an amount of SHP required to be introduced into the water system to provide water integrity.

Optionally, a water treatment system may include means of introducing desirable substances into the treated water. For example, for human consumption fluoride may be introduced. For agricultural or horticultural applications, trace elements, nutrients or treatment compounds may be introduced into a water system. Optimal levels of trace elements will be determined with respect to the nutritional requirements of the crop under cultivation. Trace elements may include, but not be limited to, bicarbonate, carbonate, hydroxide, chloride, sulfate, phosphate, ammonium, nitrate, calcium, potassium, magnesium, sodium, iron, copper, manganese and zinc. Trace elements may be introduced via a dosing apparatus and are optionally located together with a SHP dosing apparatus.

Where a groundwater source is a surface pond for irrigation use in agricultural or horticultural applications pre-treatment steps may optionally be implemented. Straw bales may be distributed on the surface of a pond for use as a first-stage control of an algae population. Bales are placed at a density of about 1 per every 200 square meters of surface area or 1 per 2.5 million L. of water. A bale is considered to be a standard 2 string bale weighing about 40 to 60 pounds. Straw bales may be from barley, oats, wheat and other appropriate plant source. Preferably bales are contained within natural fiber bags such as a jute or a burlap bag. Floats or anchoring systems may be used to position bales at or near the surface. During decomposition of the straw bale, chemical compounds are released into the water; these compounds can greatly inhibit algae growth of filamentous and other forms of algae that commonly occur in ponds. A further optional pre-treatment for control of an algae population is to the addition of trace elements which negatively affect algae growth. These may include, but not be limited to, nitrate, chloride, iron, sulfate, lead, zinc, copper, manganese, magnesium, potassium, calcium, sodium, aluminum, silver, arsenic, cadmium, chromium, and nickel. The trace elements are in such concentrations as to inhibit algae growth.

A further alternative for algae control is inclusion of copper ions in the pond water. Submersion of copper piping near an inlet to the water treatment system can provide a source of copper ions. For example a 12 inch length of 2 inch copper pipe may be split lengthwise to provide expose its surface area to the water. Copper concentration is monitored in the pond water and the amount of copper piping can be increased or decreased as required.

While the invention has been described in connection with certain embodiments thereof, the invention is capable of being practices in other forms and using other structures. Accordingly, the invention is defined by the recitations in the claims appended hereto and equivalents thereof.

1. A water treatment and distribution system comprising:
a. a groundwater source;
b. a treatment system comprising:
one or more dosing apparatus to introduce stabilized hydrogen peroxide (SHP) into the treatment system; and
one or more filter to remove particles from the treatment system;
c. a network of pipes connecting the groundwater source to the treatment system and the treatment system to a distribution system, the distribution system configured to transport water from the distribution system to at least one water outlet;
wherein the water in the distribution system contains an effective residual level of SHP.

2. The water treatment and distribution system of claim 1 further comprising one or more monitoring apparatus to measure the residual SHP level.

3. The water treatment and distribution system of claim 2 further comprising a control unit, configured to receive a signal from a monitoring apparatus providing the residual SHP level and configured to provide a signal to a dosing apparatus for control of the dosing apparatus and the effective rate of SHP introduction.

4. The water treatment and distribution system of claim 1 wherein the effective residual level of SHP level is between 1 mg/L and 8 mg/L.

5. The water treatment and distribution system of claim 1 wherein the effective residual level of SHP level is between 2 mg/L and 8 mg/L.

6. The water treatment and distribution system of claim 3 wherein the effective residual level of SHP level is between 4 mg/L and 8 mg/L.

7. A method of treatment for groundwater comprising:
a. introducing into a water treatment and distribution system, stabilized hydrogen peroxide (SHP) into a flow of water at an effective rate, the water originating from a groundwater source;
b. sampling the water in the system;
c. measuring the residual level of SHP in the sample;
d. determining whether the residual level of SHP is within pre-determined standards; and
e. if required, altering the effective rate of SHP introduction to obtain a residual hydrogen peroxide level in the system that is within the pre-determined standards.

8. The method of claim 7 wherein steps b-e are repeated a plurality of times.
